(19) United States
(12) Patent Application Publication
(10) Pub. No.: US 2014/0115690 A1
(43) Pub. Date: Apr. 24, 2014

(54) ELECTRONIC DEVICE AND METHOD FOR RELEASING SCREEN LOCKED STATE

(71) Applicant: WISTRON CORPORATION, New Taipei City (TW)

(72) Inventors: Qian Huang, New Taipei City (TW); Chun-Ming Lin, New Taipei City (TW)

(73) Assignee: Wistron Corporation, New Taipei City (TW)

(21) Appl. No.: 13/782,153

(22) Filed: Mar. 1, 2013

(30) Foreign Application Priority Data
Oct. 22, 2012 (CN) 201210404506.X

(51) Int. Cl. G06F 21/60

(52) U.S. Cl. CPC G06F 21/60
USPC 726/16

(57) ABSTRACT

An electronic device and a method for releasing a screen locked state thereof are provided. The electronic device includes a touch screen, an operating unit, a display unit and a sensing unit that are coupled to each other and apply the method for releasing a screen locked state. The method for releasing a screen locked state includes: defining a prompt area and a signal input area on the touch screen, in which the prompt area has a plurality of prompt objects; an indication object in the signal input area indicating one of the prompt objects; receiving a touch track signal to indicate different prompt objects; detecting a click signal to acquire the indicated prompt object; and when the acquired prompt objects satisfies a preset arrangement order, releasing the screen locked state.

### CROSS-REFERENCES TO RELATED APPLICATIONS

This non-provisional application claims priority under 35 U.S.C. §119(a) on Patent Application No. 201210404506.X filed in China, P.R.C. on 2012/10/22, the entire contents of which are hereby incorporated by reference.

### BACKGROUND

1. Technical Field

The present disclosure relates to an electronic device and a method for releasing a screen locked state thereof.

2. Related Art

With the rapid development of technology, various electronic products have entered people's daily life and work. The development of technology on one hand brings convenience, and on the other hand provides many operating modes very different from the past. For example, if an ordinary electronic device such as a mobile phone or a personal digital assistant (PDA) is idle for a period of time, a touch screen enters a dormant state and/or a locked state, thereby preventing a mis-touch of a user and unnecessary energy consumption. Afterwards, if the user intends to use the electronic device to execute a function, and the screen of the electronic device is in a locked state, the user has to unlock the screen before operating the electronic device.

However, such a conventional technique of pulling the virtual bar to a predetermined position to unlock the screen in a linear movement lacks user recognition. Moreover, since anyone can easily release the locked state of the electronic device, personal privacy and important electronic data are prone to being peeked or stolen at any time, which is an urgent problem to be solved by the user.

### SUMMARY

In view of this, the present disclosure provides an electronic device, which includes a touch screen, an operating unit, a display unit and a sensing unit.

The operating unit is coupled to the touch screen and defines on the touch screen a prompt area and a signal input area adjacent to the prompt area. The display unit is coupled to the operating unit, and the display unit displays a plurality of randomly arranged prompt objects in the prompt area, and displays an indication object in the signal input area to indicate one of the prompt objects. The sensing unit is coupled to the operating unit, and receives a touch track signal corresponding to the signal input area and detects a click signal corresponding to the indication object. The operating unit moves the indication object according to the touch track signal, so that the indication object indicates different prompt objects, and the operating unit acquires, according to the click signal, the prompt object indicated by the indication object, and when the acquired prompt objects satisfy a preset arrangement order, the operating unit releases a screen locked state.

The present disclosure also provides a method for releasing a screen locked state, for releasing a screen locked state of an electronic device, in which the electronic device has a touch screen. The method includes:

A prompt area and a signal input area adjacent to the prompt area are defined on the touch screen, in which a plurality of prompt objects is displayed in the prompt area, and the prompt objects are randomly arranged. An indication object is displayed in the signal input area to indicate one of the plurality of prompt objects. A touch track signal from the signal input area is received to move the indication object, so that the indication object indicates different prompt objects. A click signal corresponding to the indication object is detected to acquire the prompt object indicated by the indication object. When the acquired prompt objects satisfy a preset arrangement order, the screen locked state of the electronic device is released.

The detailed features and advantages of the present disclosure are described below in great detail through the following embodiments, and the content of the detailed description is sufficient for those skilled in the art to understand the technical content of the present disclosure and to implement the present disclosure there accordingly. Based upon the content of the specification, the claims and the drawings, those skilled in the art can easily understand the relevant objectives and advantages of the present disclosure.

### BRIEF DESCRIPTION OF THE DRAWINGS

The present disclosure will become more fully understood from the detailed description given herein below for illustration only, and thus not limitative of the present disclosure, wherein:

FIG. 1 is a schematic block diagram illustrating a connection relationship of an embodiment of the present disclosure;

FIG. 2 is a schematic flow chart (I) of an embodiment of the present disclosure;

FIG. 3 is a schematic flow chart (II) of an embodiment of the present disclosure;

FIG. 4 is a schematic flow chart illustrating setting of a preset arrangement order in the present disclosure;

FIG. 5A is a schematic view (I) illustrating display of an embodiment of the present disclosure;

FIG. 5B is a schematic view (II) illustrating display of an embodiment of the present disclosure;

FIG. 6A is a schematic view (III) illustrating display of an embodiment of the present disclosure;

FIG. 6B is a schematic view (IV) illustrating display of an embodiment of the present disclosure;

FIG. 6C is a schematic view (V) illustrating display of an embodiment of the present disclosure;

FIG. 6D is a schematic view (VI) illustrating display of an embodiment of the present disclosure; and

FIG. 7 is a schematic view (VII) illustrating display of an embodiment of the present disclosure.

### DETAILED DESCRIPTION

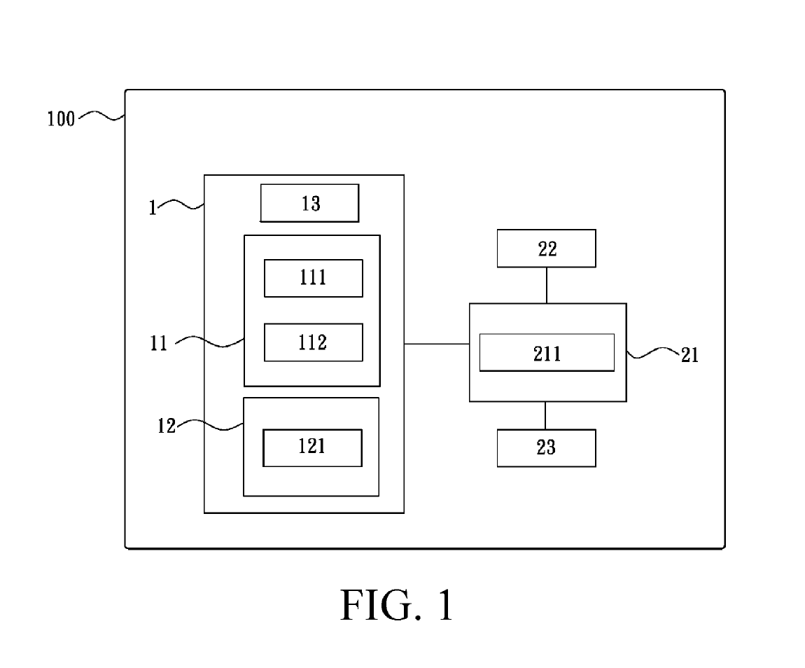

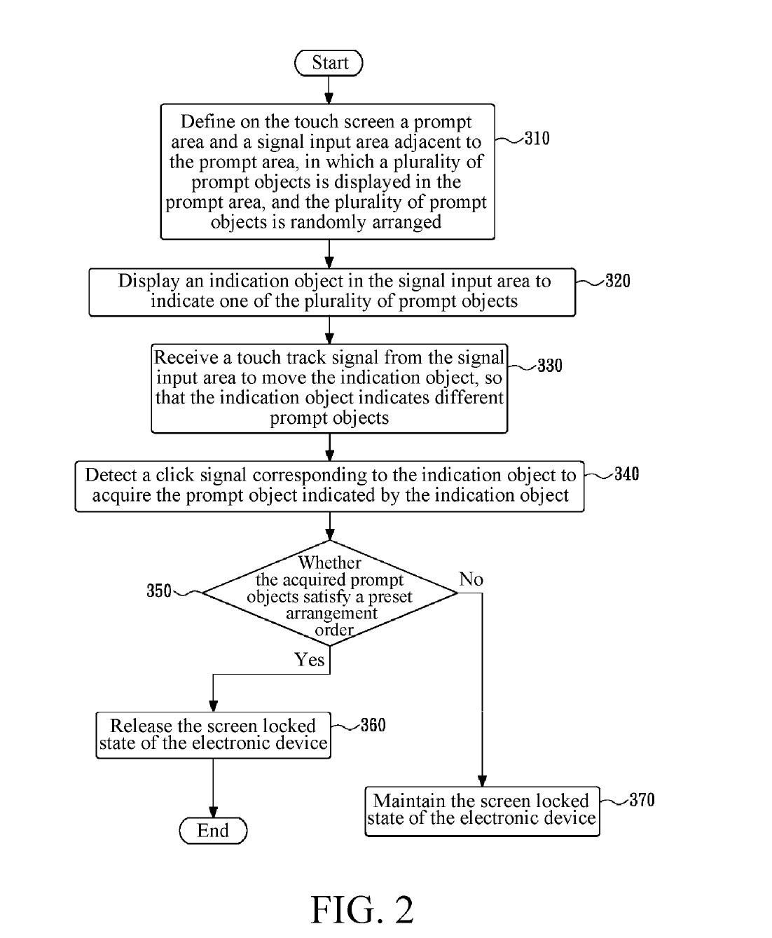

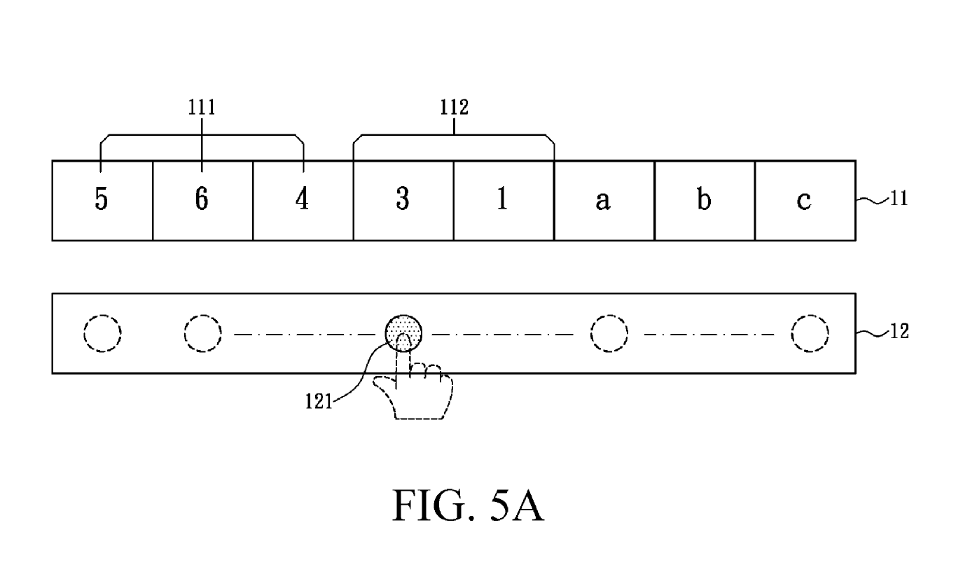

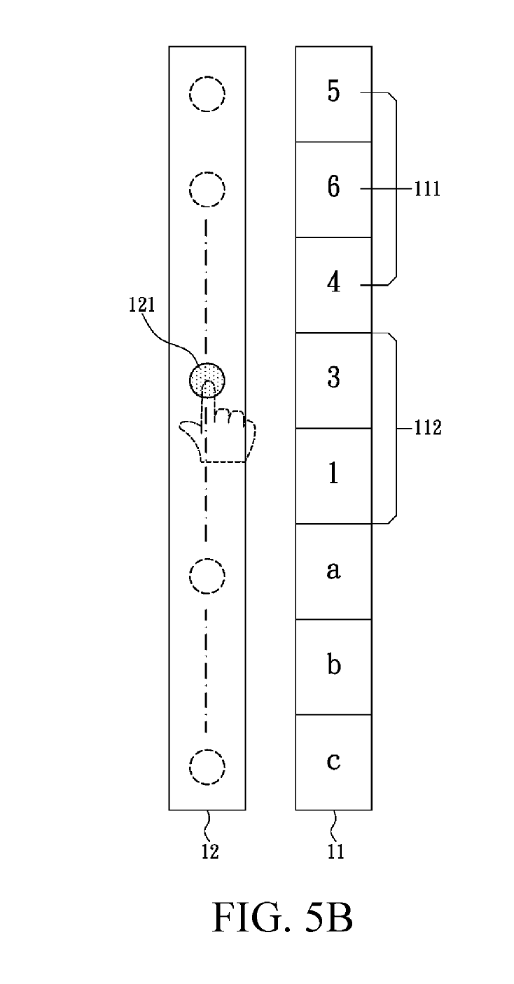

Please refer to FIG. 1, FIG. 2 and FIG. 5A, which are a schematic block diagram illustrating a connection relationship of an embodiment of the present disclosure, a schematic flow chart (I) of an embodiment of the present disclosure, and a schematic view (I) illustrating display of an embodiment of the present disclosure.

The present disclosure provides an electronic device 100. The electronic device includes a touch screen 1, an operating unit 21, a display unit 22 and a sensing unit 23.

In an embodiment, the operating unit 21 is coupled to the touch screen 1 and defines on the touch screen 1 a prompt area 11 and a signal input area 12 adjacent to the prompt area 11.

That is, the touch screen 1 displays a graphical user interface (GUI), and the operating unit 21 defines that the GUI includes a prompt area 11 and a signal input area 12, in which the prompt area 11 and the signal input area 12 are adjacent and corresponding to each other.

The display unit 22 is coupled to the operating unit 21 to receive a signal transmitted from the operating unit 21, so that the display unit 22 displays a plurality of randomly arranged prompt objects 111 in the prompt area 11. This represents that a plurality of randomly arranged prompt objects 111 is displayed in the prompt area 11 of the GUI. In some embodiments, the prompt objects 111 may be selected from a group consisting of symbols, numerals, letters, texts and combinations thereof. For example, the randomly arranged prompt objects may be a group consisting of numerals, e.g., 235698, a group consisting of letters, e.g., asdfzxcv, or a group consisting of symbols, numerals and letters, e.g., @52ak&, and the present disclosure is not limited thereto.

The display unit 22 displays an indication object 121 in the signal input area 12 to indicate one of the plurality of prompt objects 111. The indication object 121 may be a geometric pattern such as a circle or a triangle, and may also be represented by a pattern having indicating meaning such as a cursor, an arrow, a finger pattern or a penpoint pattern, but the present invention is not limited thereto. The display unit 22 receives a signal transmitted from the operating unit 21 so that the GUI of the touch screen 1 displays an indication object 121, and the indication object 121 is provided for operation of a user to indicate one of the plurality of prompt objects 111.

The sensing unit 23 is coupled to the operating unit 21, and receives a touch track signal corresponding to the signal input area 12 and detects a click signal corresponding to the indication object 121. The user inputs a touch track signal or a click signal in the signal input area 12 of the GUI, and the sensing unit 23 receives and transmits the signal to the operating unit 21.

The operating unit 21 moves the indication object 121 according to the touch track signal, so that the indication object 121 indicates different prompt objects 111. The touch track signal input by the user is transmitted to the operating unit 21 through the sensing unit 23, and the operating unit 21 moves the indication object 121 according to the touch track signal to indicate other prompt objects 111. The user may observe on the GUI that, the indication object 121 is displaced upon input of the touch track signal. In a preferred implementation aspect, the touch track of the user is formed by pressing the pattern of the indication object 121, so as to input the touch track signal.

The operating unit 21 acquires, according to the click signal, the prompt object 111 indicated by the indication object 121. In the GUI, the click signal input by the user is transmitted to the operating unit 21 through the sensing unit 23, the operating unit 21 acquires the prompt object 111 indicated by the indication object 121. The user may observe on the GUI that, upon input of the click signal, the prompt object 111 indicated by the indication object 121 generates a shape change, background change or color change to show that the prompt object 111 is acquired, an implementation aspect of which will be described later.

The sensing unit 23 receives a plurality of click signals for the operating unit 21 to acquire prompt objects 111, so as to determine whether an order of acquiring the prompt objects 111 satisfies a preset arrangement order 211, and when the order of acquiring the prompt objects 111 satisfies the preset arrangement order 211, the operating unit 21 releases a screen locked state, that is, a prompt of releasing the locked state is displayed or a working menu is shown. For example, if the plurality of randomly arranged prompt objects is acbdfe, and the preset acquisition order is abcd, the user inputs a first touch track signal to move the indication object 121 so that the indication object 121 indicates a prompt object a, and then inputs a first click signal to acquire the prompt object a; next, the user inputs a second touch track signal to move the indication object 121 so that the indication object 121 indicates a prompt object b, and then inputs a second click signal to acquire the prompt object b, and so on, till the prompt objects a, b, c and d are completely acquired according to the preset acquisition order 211, and the screen locked state is released.

In an embodiment, the sensing unit 23 detects a click signal of the indication object 121 for the same prompt object 111 again, and the operating unit 21 receives the click signal to re-acquire the prompt object 111 indicated by the indication object 121. That is, in the GUI, after the click signal is input and the prompt object 111 indicated by the indication object 121 is acquired, if the user intends to re-acquire the same prompt object 111, the user inputs the click signal again (that is, makes a second click after the previous click), and the sensing unit 23 receives and transmits the click signal to the operating unit 21 to acquire the same prompt object (that is, this prompt object is acquired twice in this implementation aspect). For example, the plurality of randomly arranged prompt objects is acbdfe, and the preset acquisition order is aaaa, the user inputs a touch track signal to move the indication object 121 so that the indication object 121 indicates a prompt object a, and then inputs a click signal four times continuously to acquire the prompt object a four times.

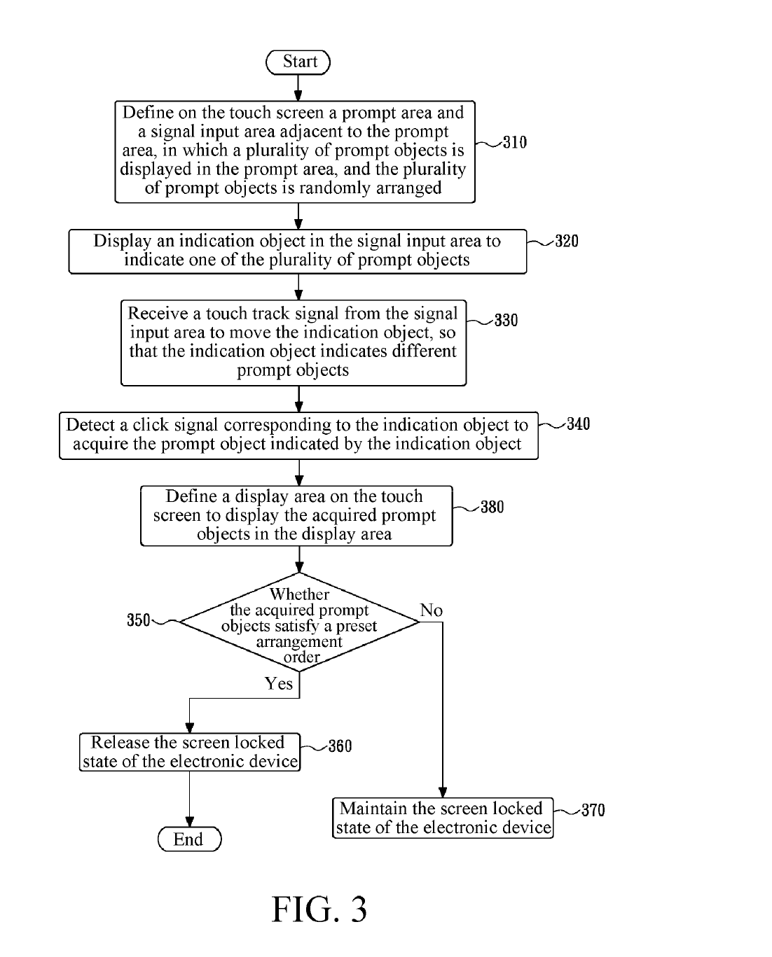

Please refer to FIG. 1 and FIG. 3, which are a schematic block diagram illustrating a connection relationship of an embodiment of the present disclosure and a schematic flow chart (II) of an embodiment of the present disclosure.

In an embodiment, the operating unit 21 defines a display area 13 on the touch screen, and when the operating unit 21 acquires prompt objects 111, the display unit 22 displays the acquired prompt objects 111 in the display area 13. In the GUI, when the click signal is input to acquire the prompt object 111, the acquired prompt object 111 is displayed in the display area 13 to remind the user. The display area 13 may be an area adjacent to the prompt area 11, and may also be in the form of a semi-transparent watermark displayed on the touch screen 1, and the present invention is not limited thereto.

In an embodiment, the display unit 22 displays a plurality of fields 112 in the prompt area 11, and the prompt objects 111 are displayed in the fields 112. The number of the fields 112 is equal to the number of the prompt objects 111, and the number of the fields 112 is greater than or equal to the number of prompt objects 111 set in the preset arrangement order 211.

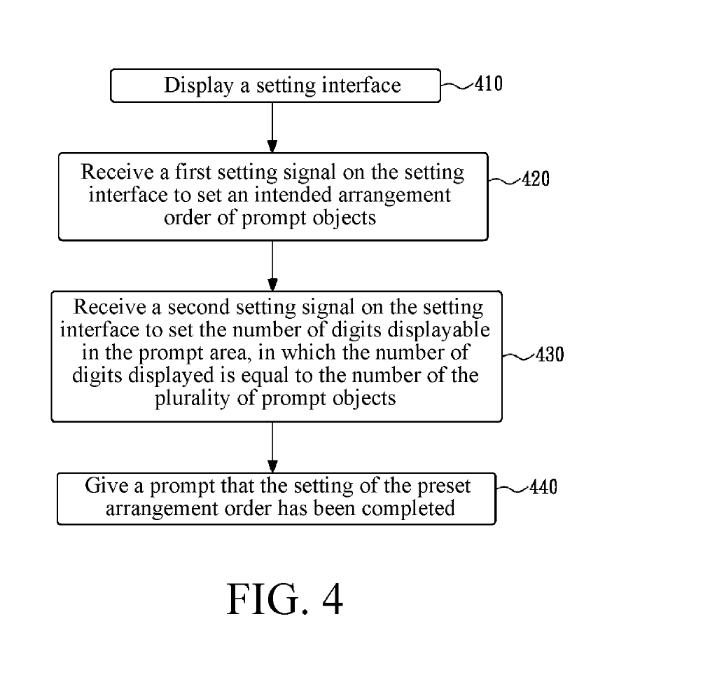

Please refer to FIG. 1 and FIG. 4, which are a schematic block diagram illustrating a connection relationship of an embodiment of the present disclosure and a schematic flow chart illustrating setting of the preset arrangement order in the present disclosure.

In an implementation aspect, the display unit 22 displays a setting interface for setting the preset arrangement order 211 of the prompt objects 111. The setting of the preset arrangement order 211 may be accomplished according to the following description.

The display unit 22 displays a setting interface, the setting interface is a GUI, and the setting interface is provided for the user to input a signal. The setting interface may display a virtual keyboard for tapping by the user, or provide a plurality of pre-grouped group options for selection by the user, or provide an input area for handwriting input by the user, and the present invention is not limited thereto.

The sensing unit 23 receives a first setting signal on the setting interface, the first setting signal is transmitted to the operating unit 21 through the sensing unit 23, and the operating unit 21 sets prompt objects 111 according to the first setting signal. In the GUI, the user inputs a first setting signal on the setting interface to select an arrangement order of prompt objects 111 intended by the user, the sensing unit 23 receives the first setting signal from the setting interface and transmits the first setting signal to the operating unit 21, and the operating unit 21 sets, according to the first setting signal, the arrangement order of the prompt objects 111 selected by the user.

The sensing unit 23 receives a second setting signal on the setting interface, the second setting signal is transmitted to the operating unit 21 through the sensing unit 23, and the operating unit 21 sets, according to the second setting signal, the number of digits displayable in the prompt area 11, in which the number of digits is equal to the number of the prompt objects 111. In the GUI, the user inputs a second setting signal on the setting interface to decide the number of digits displayed in the prompt area 11, the sensing unit 23 receives the second setting signal from the setting interface and transmits the second setting signal to the operating unit 21, and according to the second setting signal, the operating unit 21 causes the display unit 22 to display the number of digits displayed that is decided by the user.

The operating unit 21 gives a prompt on the setting interface indicating that the setting of the preset arrangement order 211 has been completed. In the GUI, after receiving and processing the above signals, the operating unit 21 causes the display unit 22 to display on the setting interface a prompt that setting is completed, to provide feedback to signal input of the user, so that the user confirms whether the setting signals are input correctly.

As shown in the above embodiments, the preset arrangement order 211 of the present invention may be selected from a group consisting of a string, a word, a sentence and a symbol arrangement, but is not limited thereto. For example, the preset arrangement order 211 may be a string without specific meaning, e.g., qazws, a word, e.g., mouse, a sentence, e.g., “You are great”, or a symbol arrangement, e.g., “@#$&”, and the present invention is not limited thereto.

In an embodiment, the prompt area 11 is parallel and corresponding to the signal input area 12, and the prompt area 11 and the signal input area 12 may be simultaneously disposed horizontally, disposed vertically or inclined at an angle. In the GUI, the touch track of the user input is in the same direction as a long direction of the signal input area 12, and the indication object 121 is also moved in the long direction of the signal input area 12 to indicate the prompt object 111 of the prompt area 11.

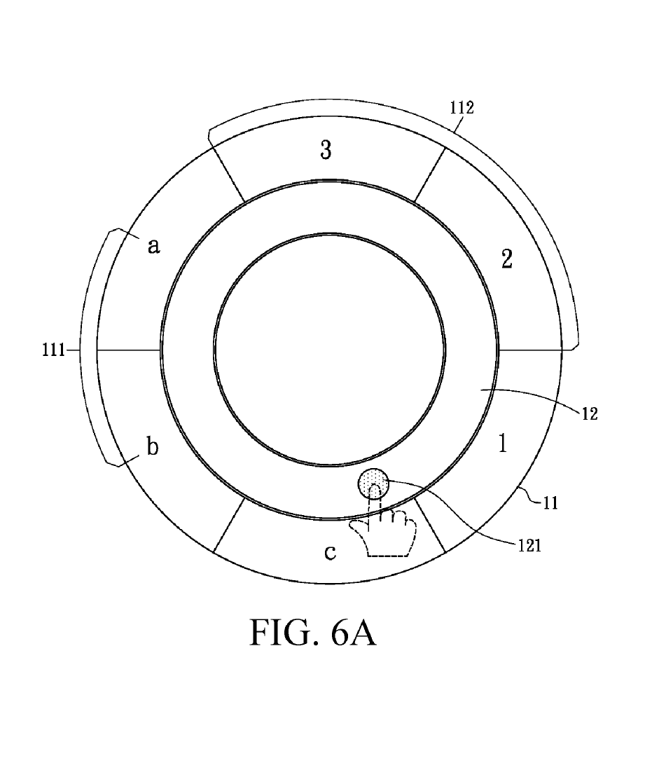

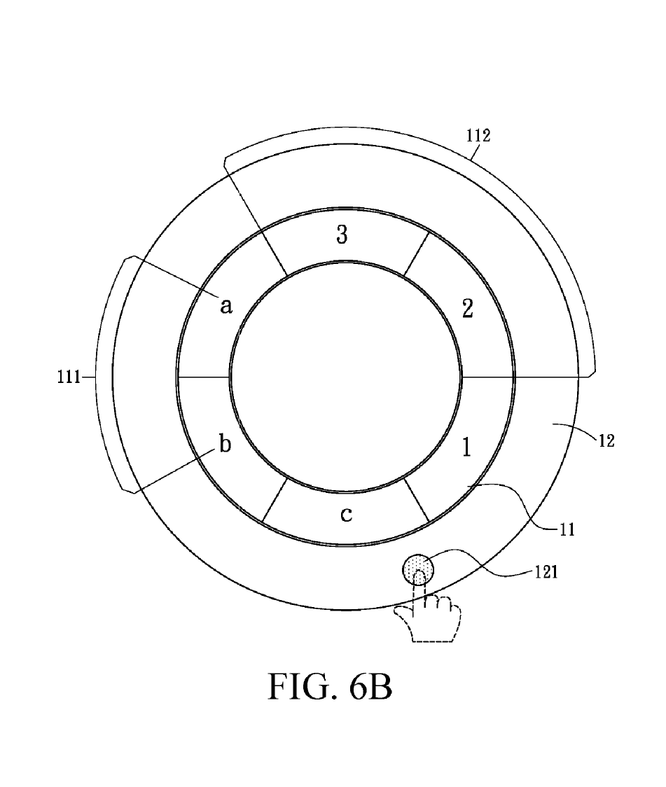

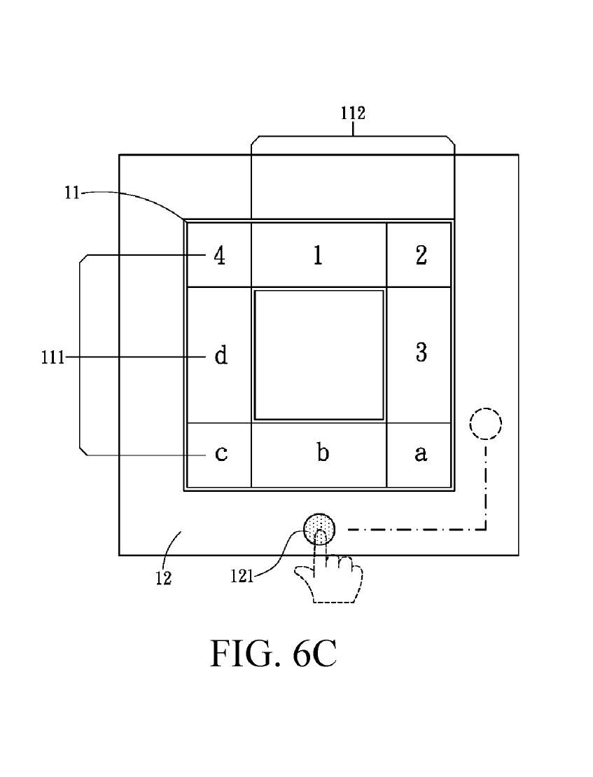

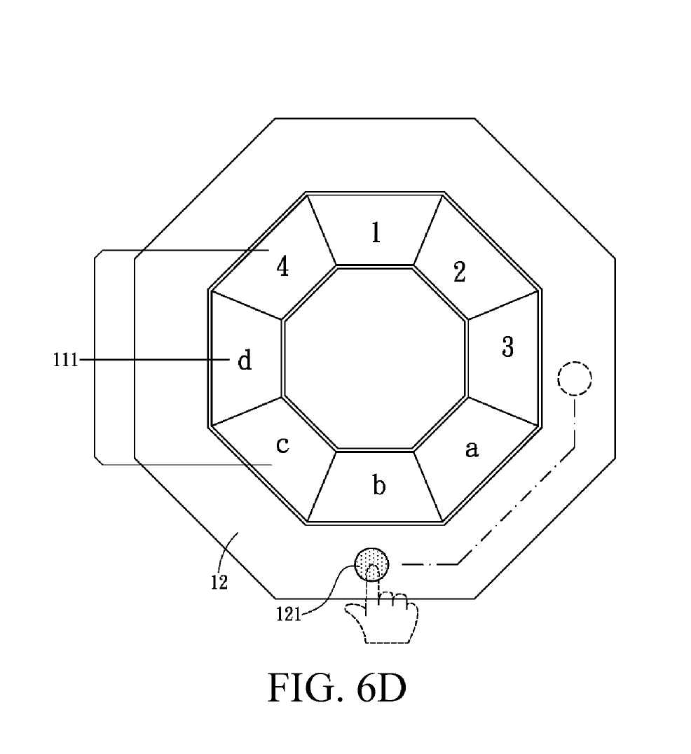

Please refer to FIG. 1, FIG. 6A, FIG. 6B, FIG. 6C and FIG. 6D, which are a schematic block diagram illustrating a connection relationship of an embodiment of the present disclosure and schematic views (III), (IV), (V) and (VI) illustrating display of embodiments of the present disclosure.

In an embodiment, the prompt area 11 surrounds the signal input area 12, or the signal input area 12 surrounds the prompt area 11, the prompt area 11 and the signal input area 12 are similar patterns and disposed concentrically, and the similar pattern is selected from a group consisting of a circle, an ellipse, a triangle, a quadrangle, a pentagon, a hexagon and other polygons. That is, in the GUI, the prompt area 11 and the signal input area 12 are configured as concentric patterns, e.g., concentric circles, or similar patterns of different sizes that are overlapped, in which sides of the two similar patterns are parallel to each other. The indication object 121 is moved in the signal input area 12 following the shape of the signal input area 12.

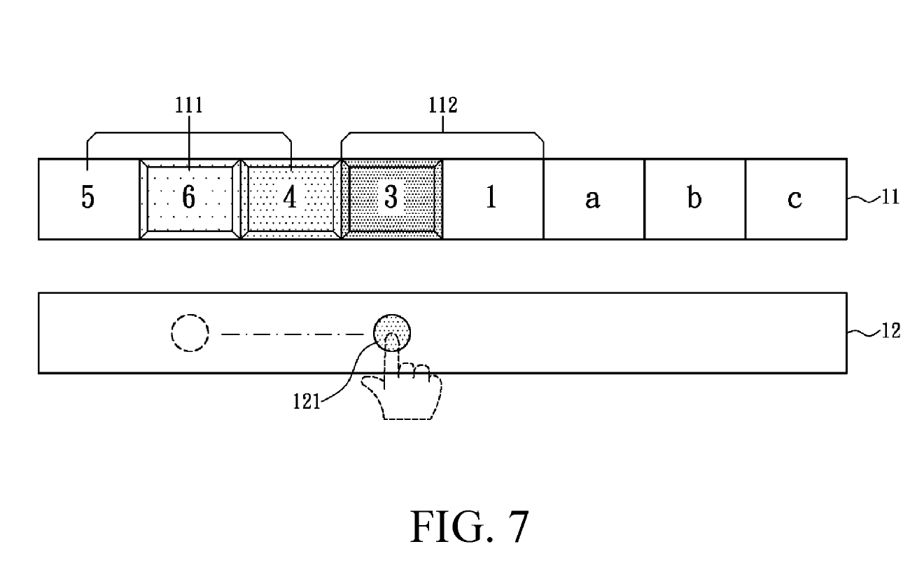

Please refer to FIG. 1 and FIG. 7, which are a schematic block diagram illustrating a connection relationship of an embodiment of the present invention and a schematic view (VII) illustrating display of an embodiment of the present invention.

In an embodiment, the prompt area 11 is an animation, and the operating unit 21 causes the display unit 22 to change display of the animation according to the click signal. That is, the change of the animation display refers to that when the operating unit 21 receives the click signal transmitted from the sensing unit 23, the operating unit 21 causes the display unit 22 to change the visual sensory effect of the prompt area 11, for example, make the prompt object 111 change color, make the prompt object 111 disappear, make the prompt object 111 shake, or make the field 112 projected, recessed or have other forms of animation display, and the present invention is not limited thereto.

In an embodiment, the operating unit 21 changes the animation display of the prompt area 11 according to the touch track signal. That is, the change of the animation display refers to that when the operating unit 21 receives the touch track signal transmitted from the sensing unit 23, the operating unit 21 causes the display unit 22 to change the visual sensory effect of the prompt area 11, for example, make the prompt objects 111 or the fields 112 have a visual effect of being wavily displaced sequentially, make the prompt objects 111 or the fields 112 have a visual effect of being enlarged sequentially, make the prompt objects 111 or the fields 112 have a visual effect of being recessed or projected sequentially, or make the prompt objects 111 or the fields 112 change color sequentially, and the present invention is not limited thereto.

The present disclosure also provides a method for releasing a screen locked state, for releasing a screen locked state of an electronic device 100, in which the electronic device 100 has a touch screen 1. The method includes the following instructions.

Instruction 310: “Define on the touch screen a prompt area and a signal input area adjacent to the prompt area, in which a plurality of prompt objects is displayed in the prompt area, and the plurality of prompt objects is randomly arranged”. That is, the touch screen displays a GUI, a prompt area and a signal input area are defined on the GUI, the prompt area and the signal input area are adjacent and corresponding to each other, and prompt objects in the GUI are randomly arranged in the prompt area. In some embodiments, the prompt objects may be selected from a group consisting of symbols, numerals, letters, texts and combinations thereof, and the present invention is not limited thereto.

Instruction 320: “Display an indication object in the signal input area to indicate one of the plurality of prompt objects”. In the GUI, the indication object may be displayed as a geometric pattern such as a circle or a triangle, and may also be represented by a pattern having indicating meaning such as a cursor, an arrow, a finger pattern or a penpoint pattern.

Instruction 330: “Receive a touch track signal from the signal input area to move the indication object, so that the indication object indicates different prompt objects”. In the GUI, upon input of the touch track signal of the signal input area, the indication object is displaced according to the touch track signal to indicate different prompt objects. In an implementation aspect, the position for receiving the touch track signal is the position for displaying the indication object, and the indication object is moved synchronously with the change of the position for receiving the touch track signal.

Instruction 340: “Detect a click signal corresponding to the indication object to acquire the prompt object indicated by the indication object”. In the GUI, upon acquisition of the prompt object indicated by the indication object, the prompt object indicated by the indication object generates a shape change, background change or color change to show that the prompt object is acquired, an implementation aspect of which will be described later.

Instruction 350: “Whether the acquired prompt objects satisfy a preset arrangement order”. After a plurality of click signals for acquiring prompt objects is detected, it is determined whether an order of acquiring the prompt objects satisfies the preset arrangement order.

Instruction 360: “When the order of acquiring the prompt objects satisfies the preset arrangement order, release the screen locked state of the electronic device”. That is, a prompt of releasing the locked state is displayed or a working menu is shown.

Instruction 370: “When the order of acquiring the prompt objects does not satisfy the preset arrangement order, maintain the screen locked state of the electronic device”.

Please refer to FIG. 3, which is a schematic flow chart (II) illustrating an operation of an embodiment of the present disclosure.

On the basis of the above embodiments, in another embodiment, the method for releasing a screen locked state in the present disclosure further includes the following instruction besides the instructions 310 to 370.

Instruction 380: “Define a display area on the touch screen, and when prompt objects are acquired, display the acquired prompt objects in the display area”. In the GUI, when a click signal is detected to acquire a prompt object, the acquired prompt object is displayed in the display area to remind the user that visual perception can be made directly. The display area may be an independent area adjacent to the prompt area, and may also be in the form of a semi-transparent watermark displayed on the touch screen, and the present invention is not limited thereto.

On the basis of the above embodiments, in another embodiment, the method for releasing a screen locked state in the present disclosure further includes the following instruction.

“Display a plurality of fields in the prompt area, in which the prompt objects are displayed in the fields”. The number of the prompt objects is equal to the number of the fields.

Please refer to FIG. 4, which is a schematic flow chart illustrating setting of the preset arrangement order in the present disclosure.

In another embodiment, the method for releasing a screen locked state in the present disclosure further includes the following instruction.

“Display a setting interface for setting the preset arrangement order of the prompt objects”.

In an implementation aspect, the setting of the preset arrangement order in the present disclosure may be accomplished according to the following instructions.

Instruction 410: “Display a setting interface”. The setting interface is a GUI, and the setting interface is provided for the user to input a signal. The setting interface may display a virtual keyboard for tapping by the user, or provide a plurality of pre-grouped group options for selection by the user, or provide an input area for handwriting input by the user, and the present disclosure is not limited thereto.

Instruction 420: “Receive a first setting signal on the setting interface to set prompt objects”. In the GUI, a first setting signal is received on the setting interface, that is, an intended arrangement order of prompt objects is set in the selection form of the previous instruction.

Instruction 430: “Receive a second setting signal on the setting interface to set the number of digits displayable in the prompt area, in which the number of digits displayed is equal to the number of the prompt objects”. In the GUI, a second setting signal is received on the setting interface, and the number of digits displayed in the prompt area is decided also in the selection form of the previous instruction.

Instruction 440: “Give a prompt that the setting of the preset arrangement order has been completed”. In the GUI, after receiving and processing the above signals, a prompt message is displayed on the setting interface indicating that the setting of the preset arrangement order has been completed, to provide feedback to signal input of the user, so that the user confirms whether the setting signals are input correctly.

As shown in the above embodiments, the preset arrangement order of the present disclosure may be selected from a group consisting of a string, a word, a sentence and a symbol arrangement, but is not limited thereto.

In an embodiment, the prompt area 11 is parallel and corresponding to the signal input area 12, and the prompt area 11 and the signal input area 12 may be simultaneously disposed horizontally, disposed vertically or inclined at an angle. In the GUI, the position for receiving the touch track signal changes in the same direction as a long direction of the signal input area 12, and the indication object 121 is also moved in the long direction of the signal input area 12 to indicate the prompt object 111 of the prompt area 11.

In an embodiment, the prompt area 11 surrounds the signal input area 12, or the signal input area 12 surrounds the prompt area 11, the prompt area 11 and the signal input area 12 are similar patterns and disposed concentrically, and the similar pattern is selected from a group consisting of a circle, an ellipse, a triangle, a quadrangle, a pentagon, a hexagon and other polygons. In the GUI, the prompt area 11 and the signal input area 12 are configured as concentric patterns, e.g., concentric circles, or similar patterns of different sizes that are overlapped, in which sides of the two similar patterns are parallel to each other. The indication object 121 is moved in the signal input area 12 following the shape of the prompt area 11.

Please refer to FIG. 7, which is a schematic view (VII) illustrating display of an embodiment of the present disclosure. In an embodiment, the prompt area 11 is an animation, and display of the animation is changed according to the click signal. That is, the change of the animation display refers to that when the click signal is received, in the GUI, the visual sensory effect presented by the prompt area 11 is changed, for example, the prompt object 111 or the field 112 changes color, the prompt object 111 or the field 112 disappears, the prompt object 111 or the field 112 shakes, the prompt object 111 or the field 112 is projected or recessed or has other forms of animation display, and the present invention is not limited thereto.

Please refer to FIG. 7 again, in which embodiment the display of the animation is changed according to the touch track signal. That is, the change of the animation display refers to that when the touch track signal is received, in the GUI, the visual sensory effect of the prompt area 11 is changed, for example, the prompt objects 111 or the fields 112 have a visual effect of being wavily displaced sequentially, the prompt objects 111 or the fields 112 have a visual effect of being enlarged sequentially, the prompt objects 111 or the fields 112 have a visual effect of being recessed or projected sequentially, or the prompt objects 111 or the fields 112 change color sequentially, and the present invention is not limited thereto.

Embodiments of the present disclosure provide that a prompt object 111 indicated by an indication object 121 is acquired from randomly arranged prompt objects 111 according to a click signal, and the indication object 121 is moved according to a touch track signal to indicate a next prompt object 111, and if the order of acquiring prompt objects 111 satisfies a preset arrangement order 211, a screen locked state is released. Since the preset arrangement order 211 is preset by a specific user, a user other than the specific user cannot know the order of acquiring the prompt objects 111, thereby solving the problem of lacking user recognition in the prior art and increasing the protection of personal privacy and important electronic data of the user.

While the present disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electronic device, comprising:
a touch screen;
an operating unit, coupled to the touch screen, for defining on the touch screen a prompt area and a signal input area adjacent to the prompt area;
a display unit, coupled to the operating unit, for displaying a plurality of randomly arranged prompt objects in the prompt area, and displaying an indication object in the signal input area to indicate one of the prompt objects; and
a sensing unit, coupled to the operating unit, for receiving a touch track signal corresponding to the signal input area and detecting a click signal corresponding to the indication object,
wherein the operating unit moves the indication object according to the touch track signal, so that the indication object indicates different prompt objects, and the operating unit acquires, according to the click signal, the prompt object indicated by the indication object, and when the acquired prompt objects satisfy a preset arrangement order, the operating unit releases a screen locked state.

2. The electronic device according to claim 1, wherein the operating unit defines a display area on the touch screen, and the display unit displays the acquired prompt objects in the display area; and wherein the display unit displays a plurality of fields in the prompt area, and the prompt objects are displayed in the fields.

3. The electronic device according to claim 1, wherein the prompt objects are selected from a group consisting of symbols, numerals, letters, texts and combinations thereof; and wherein the display unit displays a setting interface for setting the preset arrangement order of the prompt objects.

4. The electronic device according to claim 3, wherein the preset arrangement order is selected from a group consisting of a string, a word, a sentence and a symbol arrangement.

5. The electronic device according to claim 1, wherein the prompt area is parallel to the signal input area.

6. The electronic device according to claim 1, wherein the prompt area surrounds the signal input area.

7. The electronic device according to claim 1, wherein the signal input area surrounds the prompt area.

8. The electronic device according to claim 1, wherein the prompt area is an animation, and the operating unit changes display of the animation according to the click signal.

9. The electronic device according to claim 8, wherein the operating unit changes the display of the animation according to the touch track signal.

10. A method for releasing a screen locked state, for releasing a screen locked state of an electronic device, wherein the electronic device has a touch screen, the method comprising:
defining on the touch screen a prompt area and a signal input area adjacent to the prompt area, wherein a plurality of prompt objects is displayed in the prompt area, and the prompt objects are randomly arranged;
displaying an indication object in the signal input area to indicate one of the prompt objects;
receiving a touch track signal from the signal input area to move the indication object, so that the indication object indicates different prompt objects; and
detecting a click signal corresponding to the indication object to acquire the prompt object indicated by the indication object,
wherein when the acquired prompt objects satisfy a preset arrangement order, the screen locked state of the electronic device is released.

11. The method for releasing a screen locked state according to claim 10, further comprising defining a display area on the touch screen to display the acquired prompt objects in the display area.

12. The method for releasing a screen locked state according to claim 11, further comprising displaying a plurality of fields in the prompt area, wherein the prompt objects are displayed in the fields.

13. The method for releasing a screen locked state according to claim 10, wherein the prompt objects are selected from a group consisting of symbols, numerals, letters, texts and combinations thereof

14. The method for releasing a screen locked state according to claim 13, further comprising displaying a setting interface for setting the preset arrangement order of the prompt objects.

15. The method for releasing a screen locked state according to claim 14, wherein the preset arrangement order is selected from a group consisting of a string, a word, a sentence and a symbol arrangement.

16. The method for releasing a screen locked state according to claim 10, wherein the prompt area is parallel to the signal input area.

17. The method for releasing a screen locked state according to claim 10, wherein the prompt area surrounds the signal input area.

18. The method for releasing a screen locked state according to claim 10, wherein the signal input area surrounds the prompt area.

19. The method for releasing a screen locked state according to claim 10, wherein the prompt area is an animation, and display of the animation is changed according to the click signal.

20. The method for releasing a screen locked state according to claim 19, wherein the display of the animation is changed according to the touch track signal.
